(19) United States
(12) Patent Application Publication
(10) Pub. No.: US 2018/0345785 A1
(43) Pub. Date: Dec. 6, 2018

(54) DRIVELINE RAPID DISCONNECT APPARATUS

(71) Applicant: DANA AUTOMOTIVE SYSTEMS GROUP, LLC, MAUMEE, OH (US)

(72) Inventors: Peter A. BEESLEY, FORT WAYNE, IN (US); Kenneth E. COOPER, LAS VEGAS, NV (US)

(73) Assignee: DANA AUTOMOTIVE SYSTEMS GROUP, LLC, MAUMEE, OH (US)

(21) Appl. No.: 15/771,751

(22) PCT Filed: Oct. 27, 2016
(86) PCT No.: PCT/US2016/059059

§ 371 Date: Apr. 27, 2018

Related U.S. Application Data
(60) Provisional application No. 62/246,860, filed on Oct. 27, 2015.
(60) Provisional application No. 62/246,985, filed on Oct. 27, 2015.

(51) Int. Cl. B60K 17/02; B60K 23/08; F16D 11/04; F16D 11/14; F16D 28/00

(52) U.S. Cl. CPC B60K 17/02; B60K 23/0808; F16D 11/04; F16D 11/14; F16D 2011/002; B60K 2023/0825; B60K 2023/0833; B60Y 2400/422; F16D 28/00

(57) ABSTRACT

An axle disconnect apparatus having a cam cylinder with a ramp disposed therein. A first clutch element disposed at least partially inside the cam cylinder. The first clutch element includes a first inner diameter and a second inner diameter, where the second inner diameter is greater than the first inner diameter, and the second inner diameter includes a splined portion. A first biasing member and a second biasing member are disposed about the first clutch element, and a portion of the cam cylinder is engaged between the first biasing member and the second biasing member. An intermediate shaft is disposed within the first clutch element, and is in constant splined engagement with the first clutch element. A second clutch element is coupled with a half shaft disposed coaxially with the intermediate shaft. The second clutch element includes splines which are in selective engagement with splines of the first clutch element.

### RELATED APPLICATIONS

The present application claims the benefit to U.S. Provisional Application No. 62/246,860 filed on Oct. 27, 2015, and to U.S. Provisional Application No. 62/246,985 filed on Oct. 27, 2015, each of which is incorporated herein by reference in its entirety.

### BACKGROUND

The present disclosure relates to a vehicle driveline; particularly to a driveline rapid disconnect apparatus. In an all-wheel drive (“AWD”) vehicle, a primary wheel-set may be continually connected to the vehicle's power source while a secondary wheel-set is selectively connected to the vehicle's power source via a driveline disconnect apparatus.

Traditionally, an AWD vehicle was disadvantaged by lower fuel efficiency, as compared to two-wheel-drive vehicles. Even when the secondary wheel-set was not drivingly engaged with the power source, traditional drivelines required continuous rotation of a secondary drive axle at road speed. Consequently, traditional AWD vehicles would lose energy and experience decreased fuel efficiency as compared to vehicles having only a single drive axle.

Typical driveline disconnect apparatuses are utilized to disconnect many of the driveline components of the secondary wheel-set, thereby improving the fuel efficiency of the AWD vehicle. However, typical driveline apparatuses are deficient in their ability to rapidly connect and disconnect the driveline components of the secondary wheel-set.

The disclosure herein describes an apparatus and system that efficiently connects and disconnects the components of a secondary driveline.

### SUMMARY

An axle disconnect apparatus having a cam cylinder with a ramp disposed therein. A first clutch element disposed at least partially inside the cam cylinder. The first clutch element including a first inner diameter and a second inner diameter, where the second inner diameter is greater than the first inner diameter. The second inner diameter includes a splined portion. A first biasing member and a second biasing member are disposed about the first clutch element, and a portion of the cam cylinder is disposed between the first biasing member and the second biasing member. An intermediate shaft is located within the first clutch element, and is splined with the first clutch element. A second clutch element is coupled with a half shaft disposed coaxially with the intermediate shaft. The second clutch element includes splines which are in selective engagement with the splines of the first clutch element.

### BRIEF DESCRIPTION OF THE SEVERAL VIEWS OF THE DRAWINGS

The accompanying drawings are incorporated herein as part of the specification. The drawings described herein illustrate embodiments of the presently disclosed subject matter, and are illustrative of selected principles and teaching of the present disclosure and do not illustrate all possible implementations thereof. The drawings are not intended to limit the scope of the present disclosure in any way.

FIG. 1A is a schematic diagram of an AWD vehicle driveline according to an embodiment of the presently disclosed subject matter;

FIG. 1 is a schematic diagram of an AWD vehicle driveline according to an embodiment of the presently disclosed subject matter;

FIG. 2 is an illustration of a portion of a driveline rapid disconnect apparatus having a clutch in the disengaged position according to an embodiment of the presently disclosed subject matter;

FIG. 3 is an illustration of a portion of the driveline rapid disconnect apparatus according to FIG. 2, having the clutch in the engaged position;

FIG. 4 illustrates an embodiment of a cam follower of the driveline rapid disconnect apparatus according to FIG. 2;

FIG. 5 illustrates another embodiment of a cam follower of the driveline rapid disconnect apparatus according to FIG. 2;

FIG. 6 illustrates a portion of the driveline rapid disconnect apparatus according to FIG. 2, having the clutch in the disengaged position where a drag force is applied to a cam cylinder;

FIG. 7 illustrates a portion of the driveline rapid disconnect apparatus according to FIG. 2, having the clutch in the engaged position where a drag force is applied to a cam cylinder;

FIG. 8 illustrates a portion of the driveline rapid disconnect apparatus according to FIG. 2, having the cam cylinder in the engaged position where clutch engagement is blocked;

FIG. 9 illustrates a portion of the driveline rapid disconnect apparatus according to FIG. 2, having the cam cylinder in the disengaged position where clutch disengagement is prevented;

FIG. 10 is an illustration of a portion of a driveline rapid disconnect apparatus having a clutch in the engaged position according to an embodiment of the presently disclosed subject matter;

FIG. 11 illustrates a portion of the driveline rapid disconnect apparatus according to FIG. 10, having the cam cylinder in the disengaged position;

FIG. 12 is an illustration of a portion of a driveline rapid disconnect apparatus having a clutch in the disengaged position according to an embodiment of the presently disclosed subject matter;

FIG. 13 illustrates a portion of the driveline rapid disconnect apparatus according to FIG. 10, having a two-stage ramp;

FIG. 14 is an illustration of a portion of a driveline rapid disconnect apparatus having a clutch in the disengaged position according to an embodiment of the presently disclosed subject matter;

FIG. 15 illustrates an embodiment of the cam cylinder of FIG. 14;

FIG. 16 illustrates another view of the cam cylinder of FIG. 15; and

FIG. 17 illustrates a portion of the driveline rapid disconnect apparatus according to FIG. 14.

### DETAILED DESCRIPTION

It is to be understood that the invention may assume various alternative orientations and step sequences, except where expressly specified to the contrary. It is also to be understood that the specific devices, assemblies, systems and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise. Also, although they may not be, like elements in various embodiments described herein may be commonly referred to with like reference numerals within this section of the application.

Certain embodiments of a driveline rapid disconnect apparatus 200, 400, 500 are utilized with an all-wheel-drive (“AWD”) driveline assembly. However, the rapid disconnect apparatus 200, 400, 500 is not limited to use with the driveline assemblies described herein. The rapid disconnect apparatus 200, 400, 500 may be utilized with, but is not limited to, driveline assemblies of other shapes, sizes, orientations, and designs. Furthermore, it would be understood by one of ordinary skill in the art that these embodiments could have industrial, locomotive, military, and aerospace applications, as well as applications in consumer, electric, and autonomous or semi-autonomous vehicles.

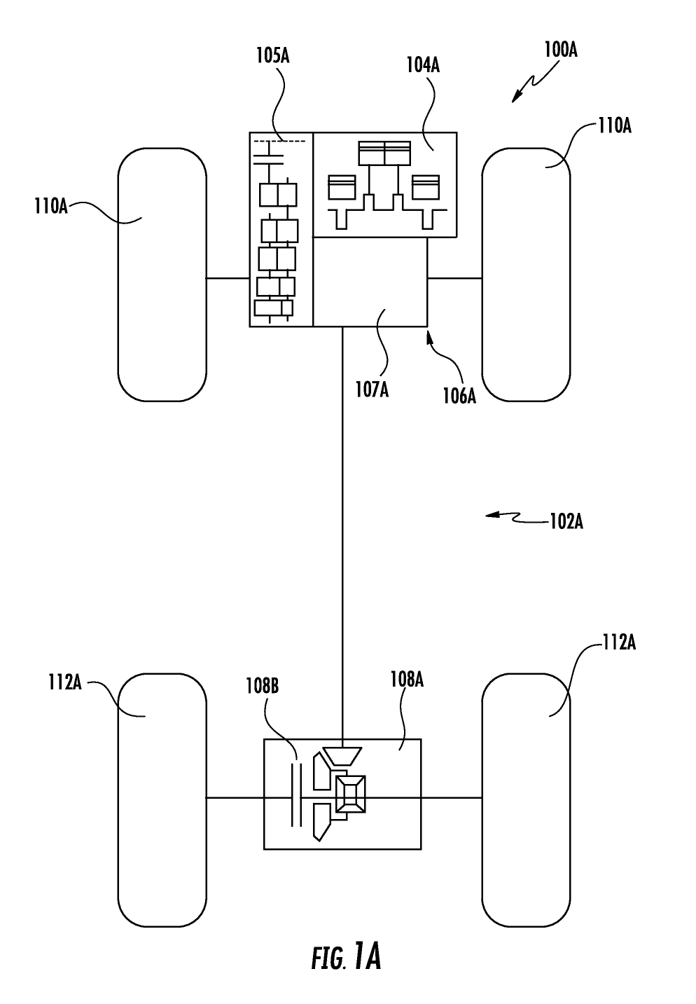

In an embodiment, as illustrated in FIG. 1A, the rapid disconnect apparatus 200, 400, 500 may be utilized in an AWD vehicle 100A having a driveline arrangement 102A with a transverse power source 104A. The power source 104A may be, but is not limited to, an internal combustion engine or an electric motor. In addition, the driveline arrangement 102A may include a transmission 105A having an input driveably connected to the power source 104A and an output driveably connected to a differential mechanism 107A. The differential mechanism 107A is driveably connected to a primary wheel-set 110A. The driveline arrangement 102A may also include a power transfer unit 106A driveably connected to the transmission 105A output, and selectively driveably connected to a secondary wheel-set 112A. The power transfer unit 106A may further comprise the rapid disconnect apparatus 200, 400, 500. When utilized in conjunction with a clutch 1086 in a rear drive unit 108A the rapid disconnect apparatus 200, 400, 500 provides improved fuel economy by disconnecting AWD driveline components when AWD functionality is not required.

As illustrated in FIG. 1, in another embodiment, the rapid disconnect apparatus 200, 400, 500 may be utilized in an AWD vehicle 100 having a driveline arrangement 102 with a longitudinal power source 104. In this embodiment, the rapid disconnect apparatus 200, 400, 500 may also be referred to as a front axle disconnect. The power source 104 may be, but is not limited to, an internal combustion engine or an electric motor. The driveline arrangement 102 may also include a transmission 105 having an input driveably connected to the power source 104 and an output driveably connected to a transfer case 106. The transfer case 106 including an output continuously driveably connected to a rear drive unit 108 and a second output selectively driveably connected to a front drive unit 107. The front drive unit 107 comprising a differential mechanism which is driveably connected to a primary wheel-set and the rapid disconnect apparatus 200, 400, 500. When utilized in conjunction with a clutch in the transfer case 106 the rapid disconnect apparatus 200, 400, 500 provides improved fuel economy by disconnecting AWD driveline components when AWD functionality is not required.

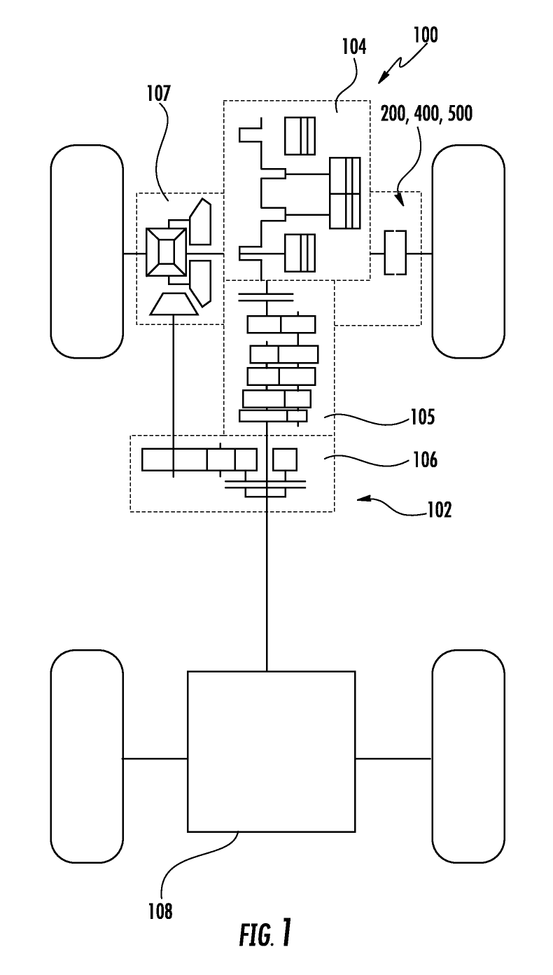

As illustrated in FIG. 2, in an embodiment, the rapid disconnect apparatus 200 includes a high speed-low torque power source 210, such as, but not limited to, a brushed direct current electric motor. The power source 210 may have an output shaft 212 with a pinion 215 coupled to an end thereof. The pinion 215 may be drivingly engaged with an idler gear 220, and the idler gear 220 may be drivingly engaged with a plurality of splines 245 disposed on a cam cylinder 240. The idler gear 220 may also be referred to herein as a drive gear. In an embodiment, additional gears (not depicted) may be operatively connected between the power source 210 and the cam cylinder 240 to obtain a desired speed reduction ratio and/or to enable specific positioning of the power source 210.

The cam cylinder 240 may be a substantially cylindrical linear-actuation structure. In an embodiment, the splines 245 may be disposed on the outer surface of a first end portion 240A of the cam cylinder 240. The splines 245 may extend longitudinally to permit full linear actuation of the cam cylinder 240 without disrupting engagement with the idler gear 220. Full linear actuation of the cam cylinder 240 may be determined by a ramp 260 disposed radially therethrough. The ramp 260 may comprise, but is not limited to, a single-stage-ramp having a dog-leg 260A and 260B at either end. In other embodiments, the ramp 260 may comprise multiple stages. The cam cylinder 240 may further comprise additional ramps (not depicted) to facilitate smooth rotation and linear actuation thereof.

The cam cylinder 240 may be disposed concentrically within an annular bushing 225. The bushing 225 may itself disposed concentrically within a stationary housing 230. A cam follower 235 may be rotatably coupled with the stationary housing 230 and slideably and rotatably disposed inside the ramp 260. Rotation of the cam cylinder 240 with the cam follower 235 inside the ramp 260 creates linear actuation of the cam cylinder 240.

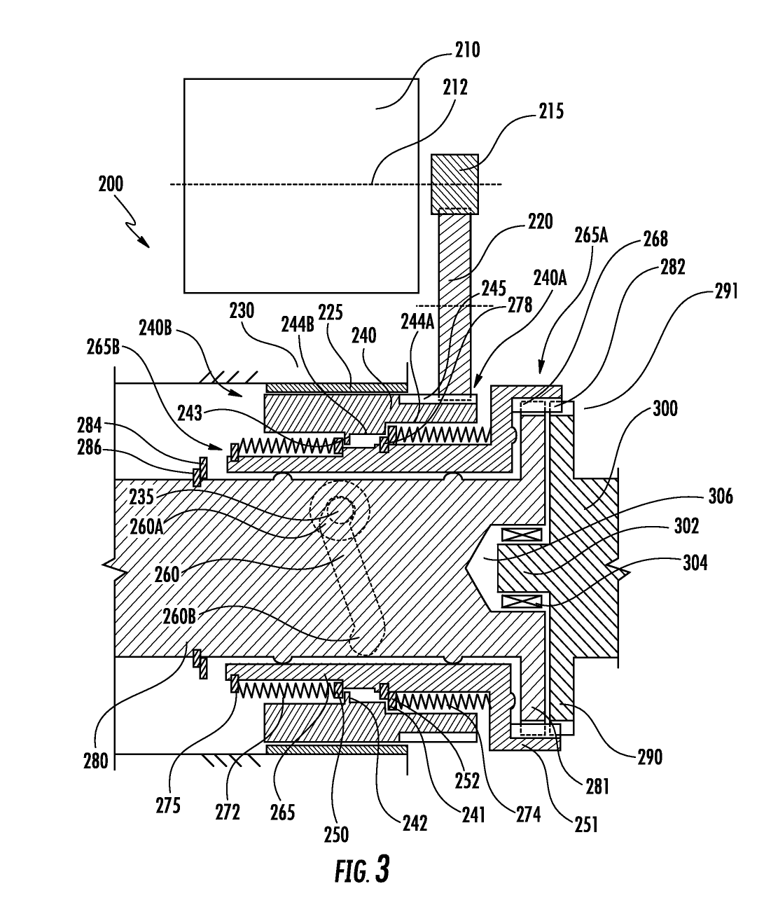

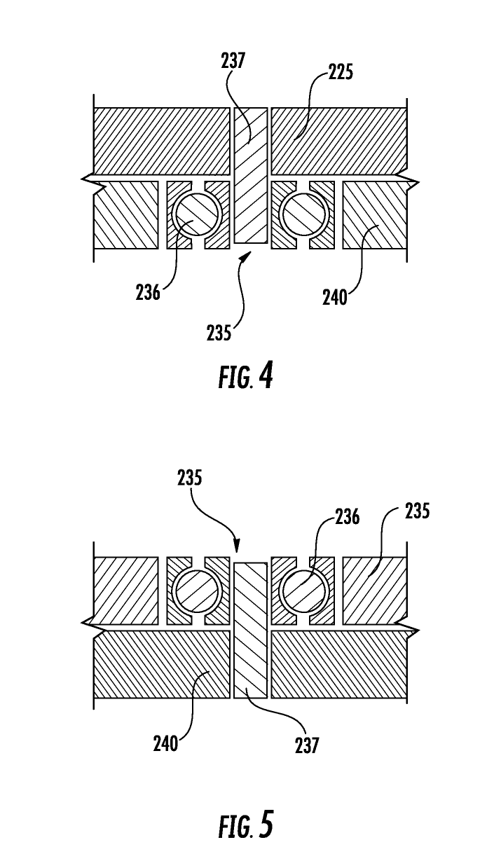

As illustrated in FIG. 4, in an embodiment, the cam follower 235 may comprise a bearing 236 having an outer race rotatably coupled inside the ramp 260. The cam follower 235 may further comprise a pin 237 having a first end coupled to an inner race of the bearing 236 and a second end fixed to the stationary housing 230. As illustrated in FIG. 5, in another embodiment, to decrease the width of the ramp 260 and increase the structural integrity of the cam cylinder 240, the cam follower 235 may be disposed such that the outer race of the cam follower bearing 236 is fixedly connected to the stationary housing 230. The cam follower 235 further comprising a first end of the pin 237 coupled to an inner race of the bearing 236 and a second end of the pin 237 disposed within the ramp 260. In an embodiment, multiple cam followers 235 may be utilized in the ramp 260 to prevent a cam follower from binding in the ramp 260 and restricting actuation of the cam cylinder 240.

In addition, the cam cylinder first end portion 240A comprises a first inner diameter 244A, and a cam cylinder second end 240B comprises a second inner diameter 244B. The first inner diameter 244A and the second inner diameter 244B define a first thrust surface 241 therebetween. When the cam cylinder 240 is actuated towards an engaged position, the first thrust surface 241 engages a first linearly actuating annular thrust washer 252. The first thrust washer 252 is slideably and concentrically disposed about an outer surface of a clutch element 265.

The cam cylinder 240 may also comprise a radially-inward extending annular protrusion 242. The protrusion 242 defines a second thrust surface 243 facing the cam cylinder second end portion 240B. First and second annular biasing members 272 and 274 may be disposed concentrically on an exterior surface of the clutch element 265. The clutch element 265 may comprise, but is not limited to, a unitary module including a clutch portion 251 disposed at a first end 265A. The clutch element 265 may be generally cylindrical in shape. The second biasing member 274 may be located between the thrust washer 252 and the clutch portion 251. The first biasing member 272 may be located between a second linearly actuating thrust washer 250, disposed concentrically and slideably on the outer surface of the clutch element 265, and a first snap ring 275 located in an annular groove disposed in a clutch element second end 265B.

Both the first and second annular biasing members 272 and 274 are continuously under compression. At its most decompressed state, the biasing member 274 drives the first thrust washer 252 into contact with a second snap ring 278. The second snap ring 278 acts as a positive stop for the first thrust washer 252.

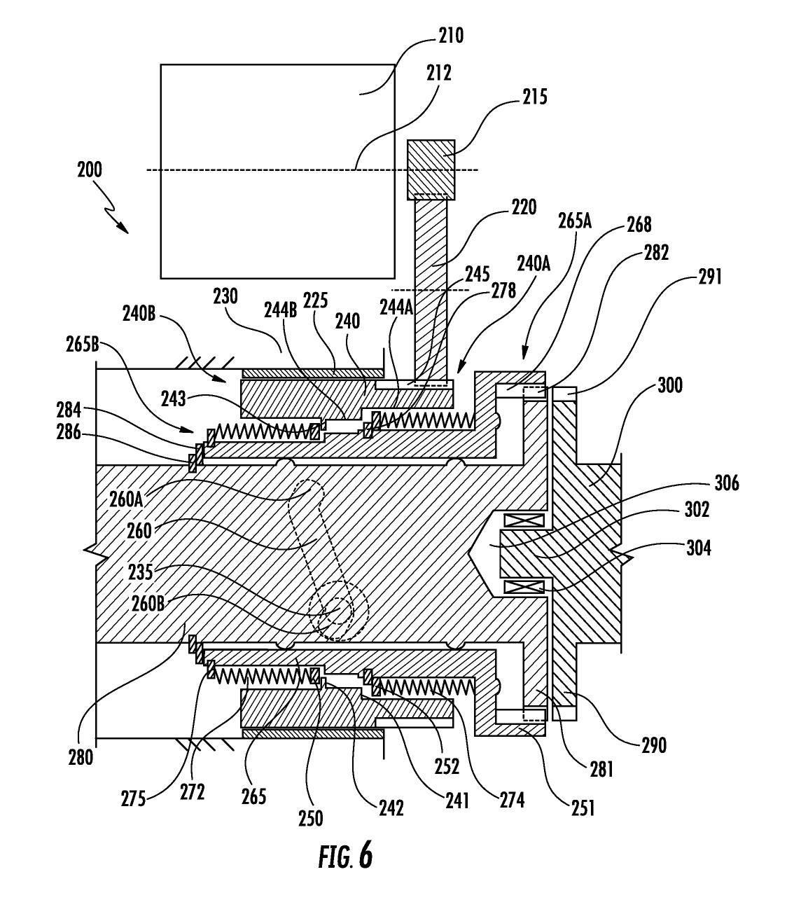

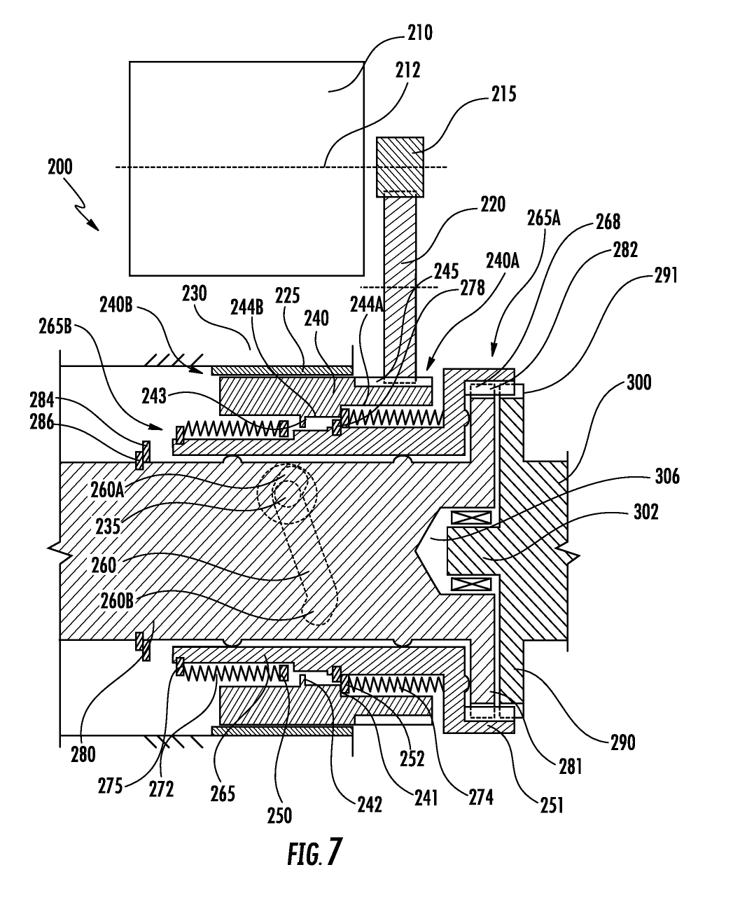

As illustrated in FIG. 6, in an embodiment, the cam cylinder 240 protrusion 242 abuts the second thrust washer 250 when the cam cylinder 240 is in a fully disengaged state, and a drag force acts on the cam cylinder 240. The annular biasing member 272 resists linear actuation of the thrust washer 250 and the cam cylinder 240, thereby keeping the cam follower 235 in the dog-leg 260B. As illustrated in FIG. 7, when the cam cylinder 240 is in a fully engaged state and a drag force acts thereon, the cam cylinder first thrust surface 241 abuts the first thrust washer 252. The annular biasing member 274 resists axial movement of the first thrust washer 252 and the cam cylinder 240, thereby securing the cam cylinder dog-leg 260A against the cam follower 235. Furthermore, the annular biasing members 272 and 274 secure the cam cylinder 240 when it is in both an engaged and disengaged state, thereby eliminating the necessity of the power source 210 to power the rapid disconnect apparatus 200 when the clutch portion 251 is in a fully engaged or disengaged state.

Referring now to FIG. 2, the clutch portion 251 may comprise a substantially cylindrical geometry having an interior surface defining splines 268. An intermediate shaft 280 is concentrically disposed through the clutch element 265. In an embodiment, the intermediate shaft 280 may comprise a clutch plate 281 coupled with an end of the intermediate shaft 280 concentrically disposed within the clutch portion 251. The clutch plate 281 includes splines 282 located on a radially outer surface of the clutch plate 281. The splines 282 are continuously engaged with the clutch portion splines 268. Additionally, the intermediate shaft 280 may be driveably connected to a differential side gear (not depicted) at an end opposite the clutch plate 281. Axial movement of the clutch element 265 toward the differential side gear is prevented by an annular thrust washer 284 disposed on the intermediate shaft 280. The annular thrust washer 284 may be axially fixed by a snap ring 286 disposed in an annular groove in the intermediate shaft 280.

A second clutch plate 290 is disposed adjacent to the clutch plate 281. The clutch plate 290 comprises radially disposed splines 291. The second clutch plate 290 is coupled to a half shaft 300. The half shaft 300 may be driveably connected to a wheel (not depicted). Further, the half shaft 300 may comprise a cylindrical axially-protruding guide 302 coupled to an annular bearing 304 that is fitted into a guide bore 306 located in an end of the intermediate shaft 280.

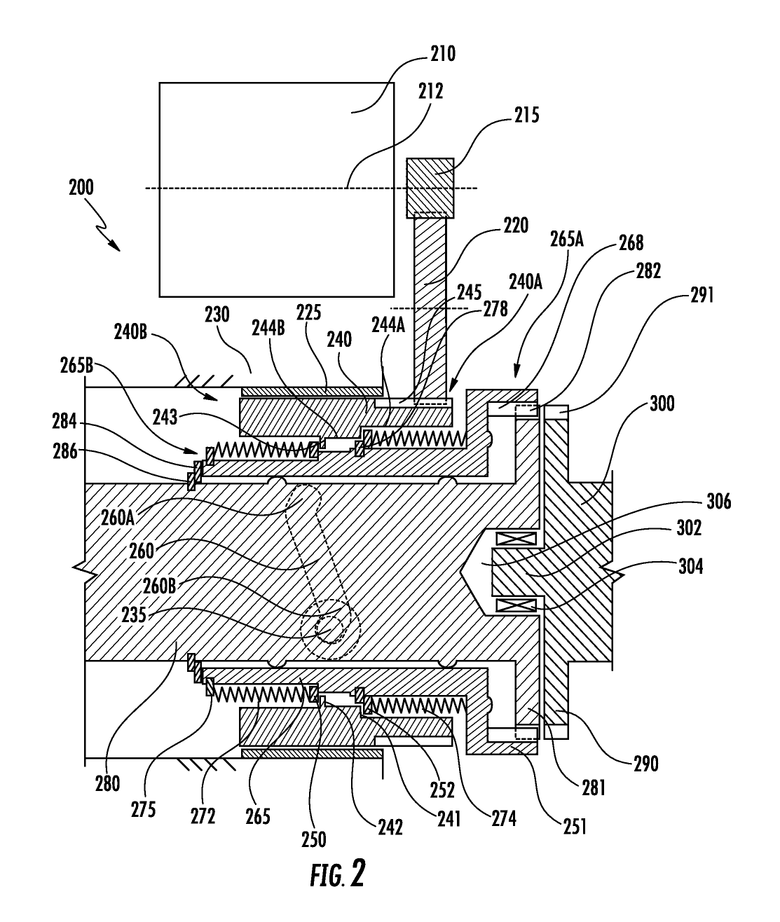

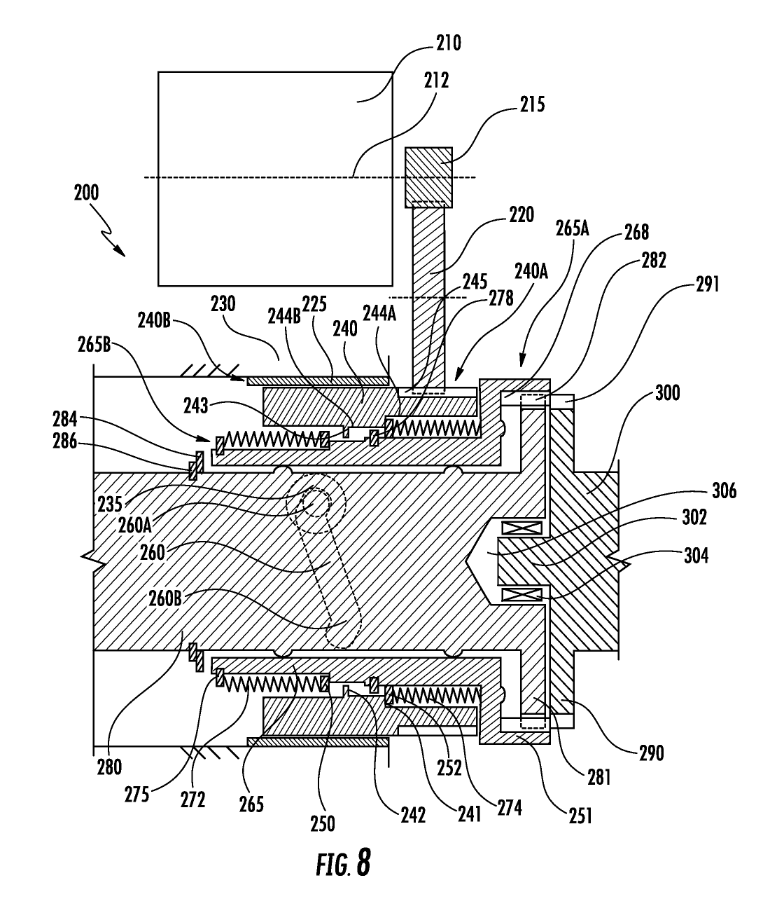

As illustrated in FIGS. 2 and 3, to connect the half shaft 300 to the driveline arrangement 102, 102A power path, the clutch portion 251 simultaneously engages the clutch plates 281, 290. To simultaneously engage the clutch plates 281, 290, the power source 210 drives the cam cylinder 240 into contact with the first thrust washer 252, the first thrust washer 252 drivingly engages the biasing member 274, and the biasing member 274 exerts an axially driving force to the clutch element 265. As illustrated in FIG. 8, if the clutch portion 251 cannot engage the clutch plate 290 because the clutch splines 268, 291 are blocking engagement, the power source 210 will drive the cam cylinder 240 into its engaged position and the cam cylinder 240 will compress the biasing member 274. When the clutch splines 268, 291 are aligned, the clutch portion 251 will be driven into engagement with the clutch plate 290 by the compressive load on the biasing member 274.

As illustrated in FIG. 9, in an embodiment, if the clutch portion 251 cannot disengage from the clutch plate 290, the power source 210 will drive the cam cylinder 240 into a disengaged position. The cam cylinder protrusion second thrust surface 243 will drive the thrust washer 250 and compress the biasing member 272. When the clutch splines 268, 291 of the clutch portion 251 and the clutch plate 290 align to permit disengagement, the compressive load on the biasing member 272 will drive the clutch element 265 to a disengaged position.

In an embodiment, the position of the power source 210 may not be usable to determine the state of engagement of the rapid disconnect apparatus 200; a sensor (not depicted) operatively disposed to determine the position of the clutch element 265 may be utilized to determine the state of engagement of the rapid disconnect apparatus 200.

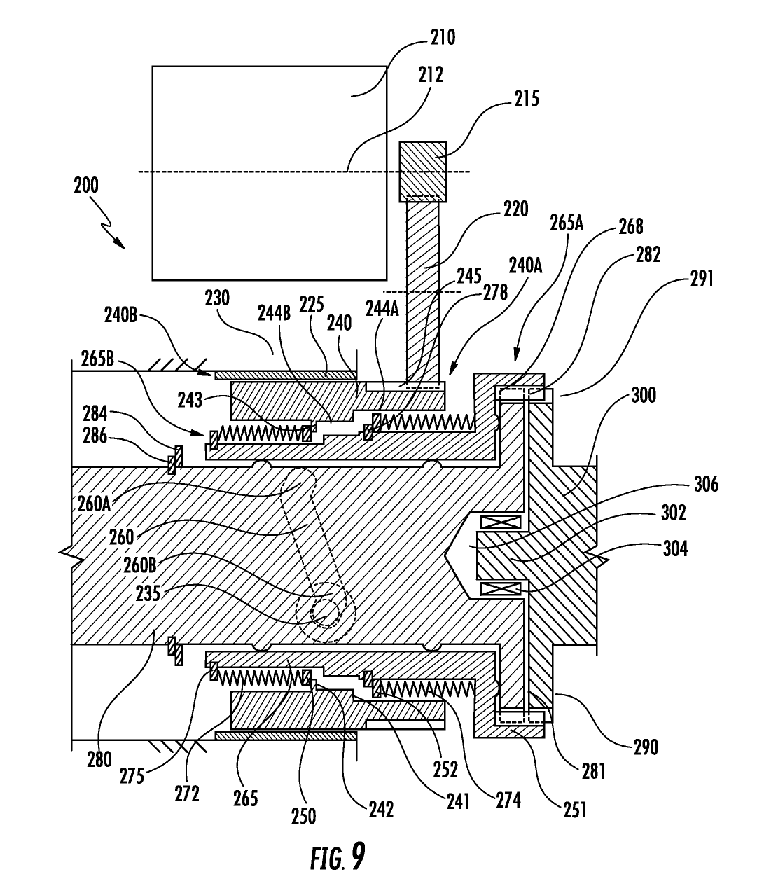

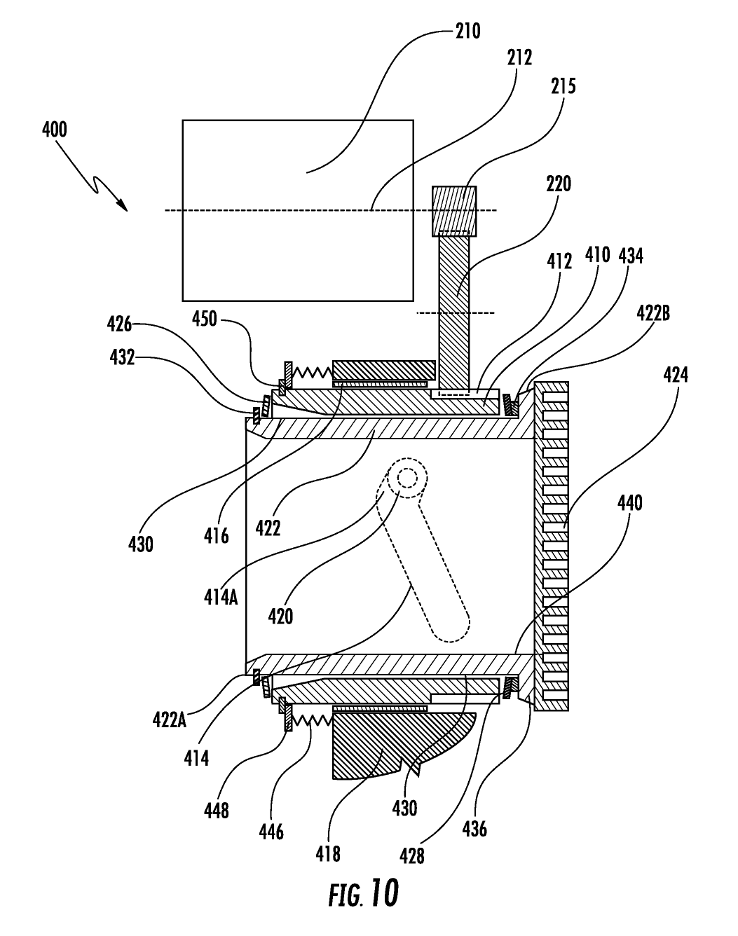

In another embodiment, as illustrated in FIGS. 10 and 11, a rapid disconnect apparatus 400 may include the power source 210, the output shaft 212, the pinion 215, and the idler gear 220, described in the disclosure of the rapid disconnect apparatus 200. The idler gear 220 is drivingly engaged with splines 412 of a cam cylinder 410. The cam cylinder splines 412 permit linear actuation of the cam cylinder 410 without disrupting engagement with the idler gear 220. The cam cylinder 410 includes a ramp 414 disposed at least partially through a radial wall of the cam cylinder 410.

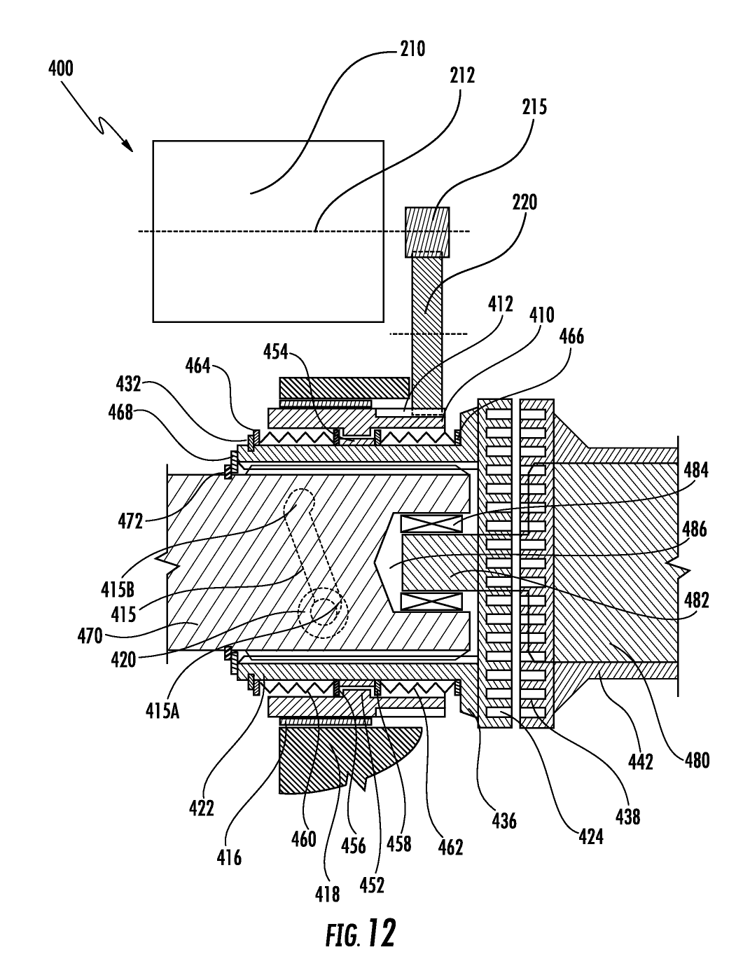

The ramp 414 may comprise, but is not limited to, a single stage ramp as illustrated in FIGS. 10 and 11, or a two stage ramp as illustrated in FIG. 13. In other embodiments, the cam cylinder 410 may include additional ramps to facilitate smooth rotation and linear actuation of the cam cylinder 410. As illustrated in FIGS. 10 and 11, a bushing 416 may be disposed between the cam cylinder 410 and a housing 418 to facilitate the rotation and linear actuation of the cam cylinder 410. A cam follower 420, similar to the cam follower 235 described supra, is coupled with the housing 418 and rotatably disposed inside the ramp 414.

A linearly actuating clutch element 422 is rotatably disposed within the cam cylinder 410. The clutch element 422 may comprise a clutch plate 424. The clutch plate 424 may be, but is not limited to, a dog-type clutch plate. Annular biasing members 426, 428 are a concentrically disposed about an outer surface 430 of the clutch element 422. The biasing member 426 is located about a first end 422A of the clutch element 422, and the biasing member 428 is located about a second end 422B of the clutch element 422. The biasing members 426, 428 may comprise, but are not limited to, spring washers or wave springs. A snap ring 432 is disposed in an annular groove in the clutch element outer surface 430 adjacent the first end 422A of the clutch element 422. The snap ring 432 prevents axial displacement of the biasing member 426. A spacer 434 is disposed on the clutch element outer surface 430, between a clutch element flange 436 and the biasing member 428.

The annular biasing members 426, 428 permit the power source 210 movement where linear actuation of the clutch element 410 is blocked during engagement of the clutch plate 424 with a clutch plate 438 because the clutch plate 424, 438 teeth are in contact, and/or where the clutch plates 424, 438 resist disengagement. Movement of the power source 210 under blocked conditions prevents cam cylinder 410 shock loads and reduces noise, vibration, and harshness in the vehicle.

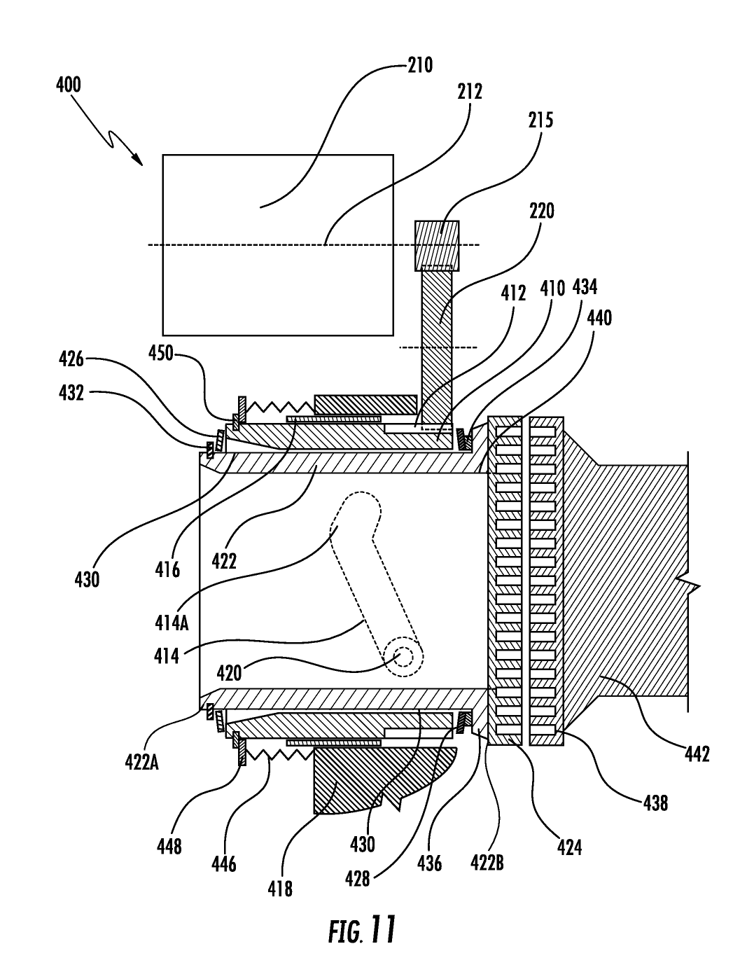

Further, the clutch element 422 includes radially inward extending splines (not depicted) located on an inner surface 440. The clutch element splines drivingly engage with splines on an intermediate shaft (not depicted) coupled with a differential side gear (not depicted). As illustrated in FIGS. 11 and 12, the clutch plate 438 is coupled with a second clutch element 442. The second clutch element 442 may be splined with an axle half shaft 480 driveably connected to a vehicle wheel. Additionally, the half shaft 480 may comprise a cylindrical, axially-protruding, guide 482 coupled to an annular bearing 484 that is fitted into a guide bore 486 located in an end of the intermediate shaft 470.

Referring now to FIG. 13, during a first stage 444A of a two-stage ramp actuation, the cam cylinder 410, and the clutch plate 424 driveably connected thereto, are driven at a high speed, but a low force, to eliminate the clearance between the clutch plate 424 and the clutch plate 438. During a second stage 444B of the two-stage ramp actuation, the cam cylinder 410 and the clutch plate 424 are driven at a lower speed, but a higher force, than during the ramp 414 first stage 444A. The velocity and force of the actuation of the clutch plate 424 in both the first stage 444A and the second stage 444B is dictated by the angle between the longitudinal axes of the ramp and a plane transverse the longitudinal axis of the cam cylinder 410.

The ramp 414 comprises a dog-leg 414A, as described supra, for limiting undesirable movement of the cam cylinder 410 when the clutch plate 424 is engaged with the clutch plate 438. A biasing member 446 may be coupled with, or abut, an end of the housing 418, and abut a washer 448 on opposite end of the biasing member 446. The washer 448 abuts a snap ring 450 disposed in an annular groove in the cam cylinder 410. The snap ring 450 acts as a positive stop for the washer 448. The annular biasing member 446 resists axial movement of the cam cylinder 410, preventing the cam follower 420 from exiting the dog-leg 414A. In combination, the dog-leg 414A and the annular biasing member 446 create a latching mechanism to prevent undesired disengagement of the clutch plate 424 and the clutch plate 438. Furthermore, the biasing member 446 secures the cam cylinder 410 in both an engaged and disengaged state, thereby eliminating the necessity of the power source 210 to power the rapid disconnect apparatus 400 when the clutch plate 424 is fully engaged/disengaged with the clutch plate 438.

In an embodiment, as illustrated in FIG. 12, the cam cylinder 410 may include a radially inward extending cam cylinder protrusion 452. The protrusion 452 may be driveably connected to a radially outward extending clutch element protrusion 454 on the clutch element 422. Adjacent both ends of the clutch element protrusion 454 are thrust washers 456, 458 disposed about the outer surface 430. A pair of biasing members 460, 462 are also disposed about the outer surface 430. The biasing members 460, 462 are positioned between the thrust washers 456, 458 and washers 464, 466, respectively. The washer 464 abuts the snap ring 432, and the washer 464 abuts the flange 436.

Additionally, in this embodiment, the cam cylinder 410 may comprise a ramp 415 having a dog-leg 415A, 415B at each end. The clutch element protrusion 454 is longer than the cam cylinder protrusion 452 such that in a fully engaged or fully disengaged position of the clutch element 422, no load is transferred from a rotating clutch element 422 to a stationary cam cylinder 410. When the clutch element 422 is in a fully disengaged state (as seen in FIG. 12), system backdrive is prevented by the dog-leg 415A and the biasing member 460. The dog-leg 415A and the biasing member 415A comprise a first latching mechanism, and the dog-leg 415B and the biasing member 462 comprise a second latching mechanism. Rotation of the cam cylinder 410 creates an axial movement away from the clutch plate 424; this axial movement of the cam cylinder 410 is resisted by the biasing member 462, and the cam follower 420 is retatined in the dog-leg 415A. When the clutch element 422 is in a fully engaged state, rotation of the cam cylinder 410 creates an axial movement of the cam cylinder 410 towards the clutch plate 424. This axial movement of the cam cylinder 410 is resisted by the biasing member 462, and the cam follower 420 is retained in the dog-leg 415B.

Further, because the biasing members 460, 462 secure the cam cylinder 410 in both an engaged and disengaged state, it is unnecessary for the power source 210 to power the rapid disconnect apparatus 400 in a fully engaged or disengaged state. Also, axial movement of the clutch element 410 toward a differential side gear (not depicted) is prevented by a washer 468. The washer 468 is disposed on an intermediate shaft 470 and axially fixed by a snap ring 472 disposed in an annular groove in the outer surface of the intermediate shaft 470.

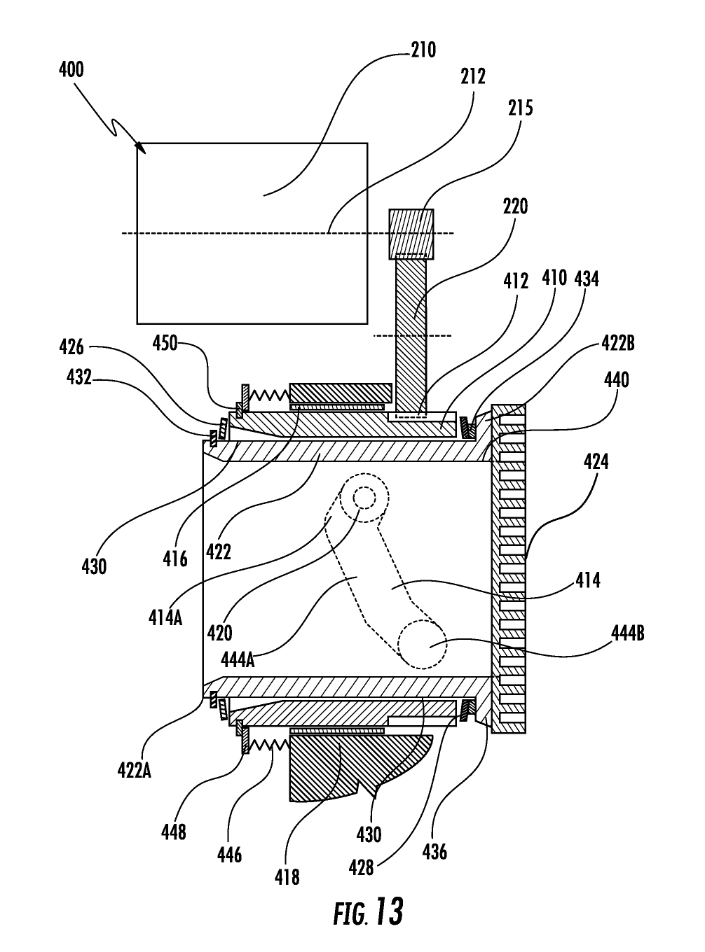

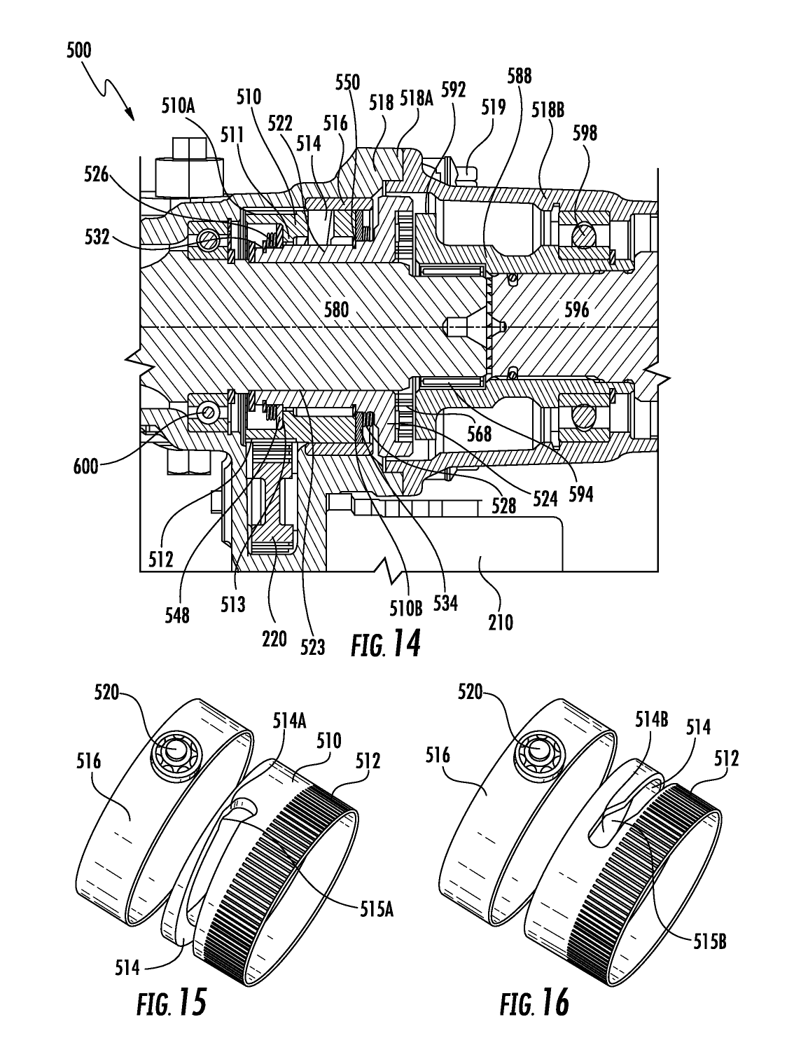

In another embodiment, as illustrated in FIG. 14, a rapid disconnect apparatus 500 includes the power source 210 drivingly connected with the idler gear 220, as described in the disclosure of the rapid disconnect apparatus 200 supra. The idler gear 220 is drivingly engaged with splines 512 of a cam cylinder 510. The cam cylinder splines 512 maintain constant engagement with the idler gear 220 while permitting linear actuation of the cam cylinder 510. In an embodiment, additional gears (not depicted) may be operatively connected between the power source 210 and the cam cylinder 510 to obtain a desired speed reduction ratio and/or to enable specific positioning of the power source 210. As illustrated in FIGS. 14-16, the cam cylinder 510 may include a ramp 514 disposed through a radial wall of the cam cylinder 510. In another embodiment, as illustrated in FIG. 17, the cam ramp 514 may be disposed in the radial wall outer surface, but not extend completely through the cam cylinder 510 radial wall.

The cam cylinder 510 comprises a portion of a linear actuator. In an embodiment, the splines 512 may be disposed on the outer surface of a cam cylinder first end portion 510A. The axial distance traveled by the cam cylinder 510 may be determined by the ramp 514. The ramp 514 may comprise, but is not limited to, a single-stage-ramp having a dog-leg 514A and 514B at either end. In certain embodiments, the ramp 514 may comprise multiple stages. The cam cylinder 510 may also comprise additional ramps (not depicted) to facilitate smooth rotation and linear actuation of the cam cylinder 510.

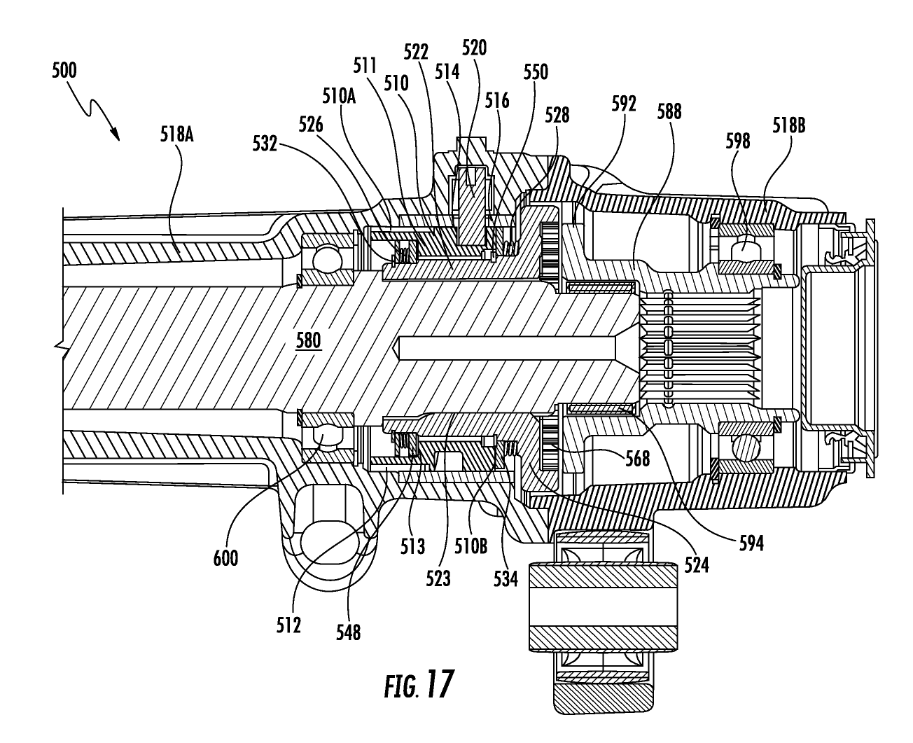

The cam cylinder 510 may be at least partially, concentrically, disposed within an annular bushing 516. The bushing 516 may itself be disposed concentrically within a housing 518. The housing 518 may comprise a first portion 518A and a second portion 518B coupled via a plurality of mechanical fasteners 519. A cam follower 520 (see FIGS. 15 and 16) may be rotatably coupled with the stationary housing 518 and slideably and rotatably disposed inside the ramp 514. Rotation of the cam cylinder 510 with the cam follower 520 inside the ramp 514 creates linear actuation of the cam cylinder 510. As illustrated supra, in FIGS. 4 and 5, the cam follower 520 may comprise a bearing having an outer race fixedly connected to the housing 518. The cam follower 520 may further comprise a first end of a pin coupled with an inner race of the bearing, and a second end of the pin disposed within the ramp 514. In another embodiment, illustrated in FIG. 17, the cam follower 520 may comprise a needle bearing having an outer race fixedly connected to the housing 518. One end of the pin may be in direct contact with the needle bearing rollers, and the opposite end of the pin may be disposed within the ramp 514.

In addition, the cam cylinder 510 comprises a first end 5106 abutting a first thrust washer 534. The first thrust washer 534 is slideably and concentrically disposed about an outer surface of a clutch element 522. The cam cylinder 510 may also comprise a radially-inward extending annular protrusion 511. The protrusion 511 defines a thrust surface 513. The thrust surface 513 abuts a second thrust washer 548 disposed concentrically and slideably on the outer surface of the clutch element 522. A first biasing member 526 is disposed about the clutch element 522 outer surface between the second thrust washer 548 and a first snap ring 532. The snap ring 532 is disposed in a groove in the outer surface of the clutch element 522.

A second biasing member 528 is disposed between the first thrust washer 534 and a clutch element clutch portion 524. The second biasing member 528 may comprise a first end abutting the first thrust washer 534, and a second end abutting a thrust surface defined by the clutch portion 524. The first and second biasing members 526, 528 may be disposed concentrically on an exterior surface of the clutch element 522. Both the first and second biasing members 526, 528 are continuously under at least some compression. At its most decompressed state, the second biasing member 528 drives the first thrust washer 534 into contact with a second snap ring 550. The second snap ring 550 acts as a positive stop for the first thrust washer 534.

The clutch element 522 may comprise, but is not limited to, a unitary module including the clutch portion 524. The clutch element 522 may have a substantially cylindrical geometry, including a first inner diameter defining splines 523. An intermediate shaft 580 is concentrically disposed through the clutch element 522. The intermediate shaft 580 may comprise splines 582 in constant engagement with the clutch element splines 523.

The clutch portion 524 is generally cylindrical and comprises a second inner diameter having radially-inward projecting splines 568. The second inner diameter of the clutch portion 524 is greater than the first inner diameter of the clutch element 522. The clutch portion splines 568 may be referred to as inwardly projecting gear teeth. The clutch portion splines 568 are selectively engaged with splines 592 on a second clutch portion 588. The second clutch portion 588 may be an axially-stationary member disposed at least partially about an end of the intermediate shaft 580. A bearing 594, which may be, but is not limited to, a needle bearing, is located radially between a portion of the intermdediate shaft 580 and the second clutch portion 588. The second clutch portion 588 is further disposed about and splined with an axle half shaft 596. The axle half shaft 596 may be rotationally supported in the housing 518B via a bearing 598. The intermediate shaft 580 may be supported within the housing 518A via a bearing 600.

As illustrated in FIGS. 15 and 16, the cam cylinder 510 may comprise a ramp 514 having a deceleration stage 514A, and/or a deceleration stage 514B. In an embodiment, the deceleration stages 514A, 514B are disposed at each end of the ramp 514, respectively. The deceleration stages 514A, 5146 may be disposed at an oblique angle to a respective ramp dog-leg 515A, 515B. The deceleration stage 514A allows the power source 210 to operate at a higher speed for a longer period of time. Operating the power source 210 at a higher speed for a longer period of time has the benefit of reducing the clutch portion 524, 588 engagement/disengagement time.

To connect the half shaft 596 to the driveline arrangement 102, 102A power path, the clutch portion 524 engages the clutch portion 588. To engage the clutch portions 524, 588, the power source 210 drives the cam cylinder 510 into contact with the first thrust washer 534, the first thrust washer 534 drivingly engages the biasing member 528, and the biasing member 528 exerts an axially driving force to the clutch element 522. In this embodiment, if the clutch portion 524 cannot engage the clutch portion 588 because the clutch splines 523, 592 are blocking engagement, the power source 210 will drive the cam cylinder 510 toward the engaged position until the clutch splines 523, 592 are aligned and engage. In this embodiment, the biasing member 528 is not long enough to lock the cam cylinder 510 into the engaged position during a blocked clutch engagement. Therefore, the power source 210 continuously drives the cam cylinder 510 toward engagement until the clutch teeth 523, 592 are aligned. In an embodiment, the biasing member 526 may not be long enough to lock the cam cylinder 510 into the disengaged position during a blocked clutch disengagement. Therefore, the power source 210 may continuously drive the cam cylinder 510 toward disengagement until the clutch teeth 523, 592 are aligned. Utilizing a shortened biasing member 526, 528 provides the rapid disconnect apparatus 500 with a faster reaction time.

While various embodiments of the presently disclosed subject matter have been described above, it should be understood that they have been presented by way of example, and not limitation. It will be apparent to persons skilled in the relevant art(s) that the disclosed subject matter may be embodied in other specific forms without departing from the spirit or essential characteristics thereof. The embodiments described above are therefore to be considered in all respects as illustrative, not restrictive.

1-13. (canceled)

14. An axle disconnect apparatus, comprising:
a cam cylinder having a ramp disposed therein;
a first clutch element disposed at least partially inside said cam cylinder, wherein said first clutch element including includes a first inner diameter and a second inner diameter, said second inner diameter being greater than said first inner diameter;
said second inner diameter including a splined portion;
a first biasing member disposed about said first clutch element;
a second biasing member disposed about said first clutch element, whereby a portion of said cam cylinder is engaged between said first biasing member and said second biasing member;
an intermediate shaft disposed at least partially within said first clutch element, wherein said intermediate shaft having includes a splined portion in constant mesh with said first clutch element;
a half shaft disposed coaxially with said intermediate shaft; and
a second clutch element coupled with said half shaft, wherein said second clutch element having includes splines a splined portion in selective engagement with said first clutch element splined portion.

15. The axle disconnect apparatus of claim 14, comprising:
a housing; and
a cam follower including a bearing coupled with said housing, a pin having a first end coupled with said bearing, and a second end of said pin disposed in said ramp.

16. The axle disconnect apparatus of claim 14, comprising:
a housing; and
a cam follower comprising a pin having a first end coupled with said housing, and a second end of said pin coupled with a bearing, wherein said bearing is disposed within said ramp.

17. The axle disconnect apparatus of claim 15, wherein said ramp comprises further comprising:
a dog-leg disposed at an end of said ramp, wherein said first biasing member at least partially decompresses when said cam follower enters said dog-leg.

18. The axle disconnect apparatus of claim 14, wherein said ramp comprises:
a first dog-leg at a first end of said ramp; and
a second dog-leg at a second end of said ramp.

19. The axle disconnect apparatus of claim 14, wherein said ramp comprises:
a first deceleration stage at a first end of said ramp; and
a second deceleration stage at a second end of said ramp.

20. The axle disconnect apparatus of claim 14, wherein said ramp comprises:
a first stage; and
a second stage.

21. The axle disconnect apparatus of claim 14, wherein said cam cylinder comprises:
a plurality of splines disposed on an outer surface of said cam cylinder.

22. The axle disconnect apparatus of claim 14, comprising:
a first thrust washer slideably disposed about an outer surface of said first clutch element, wherein said first thrust washer abuts a first portion of said cam cylinder;
a thrust surface defined by a portion of said first clutch element;
a first end of said second biasing member abutting said first thrust washer; and
a second end of said second biasing member abutting said thrust surface.

23. The axle disconnect apparatus of claim 22, comprising:
a first snap ring disposed in groove in an outer surface of said first clutch element;
a second thrust washer slideably disposed about said first clutch element outer surface, wherein said second thrust washer abuts a second portion of said cam cylinder;
a first end of said first biasing member abutting said first snap ring; and
a second end of said first biasing member abutting said second thrust washer.

24. The axle disconnect apparatus of claim 14, comprising:
a power source;
a drive gear driveably connected with said power source; and
a plurality of splines disposed on said cam cylinder, whereby said cam cylinder is driveably connected with said drive gear.

25. The axle disconnect apparatus of claim 14, comprising:
a housing; and
a bushing disposed between said housing and at least a portion of said cam cylinder.

26. The axle disconnect apparatus of claim 14, wherein:
at least a portion of said first clutch element is concentric with said cam cylinder;
at least a portion of said intermediate shaft is concentric with said first clutch element;
at least a portion of said first biasing member is concentric with said first clutch element; and
at least a portion of said second biasing member is concentric with said first clutch element.
